(19) United States
(12) Patent Application Publication
(10) Pub. No.: US 2013/0337276 A1
(43) Pub. Date: Dec. 19, 2013

(54) PLASTIC PART HAVING A LAYERED, DECORATIVE, COLORED-METAL FINISH

(71) Applicants: Matthew R. Graves, Royal Oak, MI (US); Kelly L. Meland, Clinton Twp., MI (US)

(72) Inventors: Matthew R. Graves, Royal Oak, MI (US); Kelly L. Meland, Clinton Twp., MI (US)

(73) Assignee: GLOBAL IP HOLDINGS, LLC, Sterling Heights, MI (US)

(21) Appl. No.: 13/526,860

(22) Filed: Jun. 19, 2012

(51) Int. Cl. B32B 15/20

(52) U.S. Cl. 428/457

(57) ABSTRACT

A plastic part such as an automotive vehicle interior plastic part having a layered, decorative, colored-metal finish is provided. The part includes a plastic substrate, a base coat layer overlying the substrate, and a continuous decorative metal layer overlying the base coat layer. The part also includes an intermediate color layer having coloring agents and overlying the decorative metal layer. The color layer includes a UV absorber sufficient to stabilize the coloring agents of the color layer by absorbing UV light without adversely affecting the color of the color layer. The part further includes a clear top coat layer overlying and protecting the color layer.

### TECHNICAL FIELD

This invention relates in general to the field of plastic parts and, more particularly, to plastic parts having a layered, decorative, colored-metal finish which may be used in a vehicle interior.

### OVERVIEW

Many automotive vehicle exteriors have metallic finishes such as copper-colored finishes. Physical vapor deposition (PVD), such as vacuum metallization (VM), is a vacuum coating technique that can be used to deposit thin film coatings. Vacuum metallizing is a process where a metallic coating material is placed in a vacuum chamber with the workpiece to be coated. The material that is being applied is then heated until it starts to evaporate. The vaporized metal condenses on the product or workpiece as a thin metallic film. Thickness ranges typically from 0.01 to 0.2 micrometers. Some target metals are aluminum, copper, platinum, titanium, chromium titanium, gold, lead, nickel, silver, tin and tantalum.

In order for the thin metallic film to adhere to a substrate such as a plastic substrate, a base coat layer is typically provided to adhere to both the substrate (or an intermediate layer) and the metallized surface.

Painted colored top coats over a VM layer typically have poor durability due to UV exposure. Such painted colored coatings typically lack UV stabilizing components in its pigment or coloring agent. Adding UV inhibitors to the top coat requires additional UV energy to properly cure the top coat which, in turn, affects the pigment and end color of the finished product. The pigment in the top coat also results in poor durability for applications requiring resistance to scratching and marring.

The following U.S. patent documents are related to the present invention: U.S. Pat. Nos. 4,833,038; 6,625,949; 6,733,870; 6,916,508; 7,297,397; 8,101,264; 2002/0119259; 2005/0175843; and 2008/0085402.

### UV-Absorbent Pigments

Incorporation of pigments is probably the oldest way of providing protection against UV light. Titanium dioxide and carbon black are both capable of absorbing UV light and thus help to stabilize paint films. Pigments such as titanium dioxide can also cause photo-oxidative degradation of polymers. However, titanium dioxide is available in various forms, namely anatase (treated or untreated) and rutile (treated or untreated). Titanium dioxide can initiate polymer degradation, depending on the way it has been modified and treated, to form hydroxyl and hydroperoxide radicals.

Pigments can act as UV absorbers but only under certain conditions.

### UV Absorbers

The main function of UV absorbers is to absorb UV radiation in the presence of a chromophore (Ch) found in the polymer, the aim being to filter out the UV light that is harmful to the polymer before Ch* has had a chance of forming. Above all, a UV absorber must function within the 290 and 350 nm range. However, these data need to be modified to allow for possible impurities, which are unavoidable in industrially produced polymers, as well as additives, pigments, extender pigments or even dyes. Accordingly, the UV absorber should also be able to absorb light at higher wavelengths, without adversely affecting the color of the cured coating.

The purpose of UV absorbers is to absorb harmful UV light and quickly transform it into harmless heat. During this process, absorbed energy is converted into vibrational and rotational energy of the molecule constituents. For UV absorbers to be effective, it is important that this process take place more rapidly than the corresponding reaction within the substrate, and that neither the UV absorber nor the polymer it is intended to stabilize are damaged during energy conversion. Some important UV absorbers are:

a) 2-(2-hydroxyphenyl)-benzotriazoles

b) 2-hydroxy-benzophenones

c) hydroxyphenyl-s-triazines

d) oxalanilides

Each of these UV absorber groups can be characterized by a typical absorption and transmission spectrum.

Extinction depends on wavelength and can be regarded as a measure of the stabilizing or screening effect of the UV absorber. In other words, the higher the extinction, the higher the UV light screening and the greater the stabilizing effect—assuming that the UV absorber is not itself destroyed by the absorption of the light. Extinction thus depends on the extinction coefficient, the concentration, “c”, of the UV absorber in the polymer, and on the film thickness, “d”, of the unpigmented polymers.

For a UV absorber to be effective, it must absorb UV light better and faster than the polymer it is meant to stabilize and dissipate the absorbed energy before unwelcome side reactions are triggered.

### SUMMARY OF EXAMPLE EMBODIMENTS

As used in this application, the term “substrate” refers to any flexible, semi-flexible or rigid single or multilayer component having a surface to which a decorative coating is or can be applied by the methods described herein such as, without limitation, polymers and other plastics, as well as composite materials. Furthermore, the shape of the substrate and particularly the surface to be coated can be any part of an assembly or device manufactured by any of various methods, such as, without limitation, conventional molding, extruding, or otherwise fabricated. One preferred application contemplated herein is the coating of substrates that are automotive components such as automotive interior trim components.

As used herein, “radiation'cured” refers to a process for curing a material or layer of material, as well as to compositions or materials cured or curable as described in this paragraph, wherein curing is initiated and caused to proceed through the introduction of or in response to some form of electromagnetic radiation. Herein it is preferred the electromagnetic radiation used to cure a radiation-cured composition or layer is ultraviolet radiation (“UV”). Alternatively, other wavelengths of electromagnetic radiation can be used based on selection of appropriate curing initiators, sometimes called photoinitiators, as is well understood in the art, for example radiation that is more or less energetic than ultraviolet radiation, typically X-rays or visible light. In addition, the radiation can be provided in a variety of forms, e.g. it can be supplied from appropriately filtered incandescent bulbs, electron beam radiation, lamps that emit radiation incident to an electrical discharge, such as the well known mercury discharge lamps for generating “UV” radiation, etc. A radiation-cured material or composition is not necessarily intended to imply that the composition or material excludes (i.e. will not also be cured via) other modes of cure or cross-linking initiation; e.g. heat.

The term “overlies” and cognate terms such as “overlying” and the like, when referring to the relationship of one or a first, superjacent layer relative to another or a second, subjacent layer, means that the first layer partially or completely lies over the second layer. The first, superjacent layer overlying the second, subjacent layer may or may not be in contact with the subjacent layer; one or more additional layers may be positioned between respective first and second, or superjacent and subjacent, layers.

An object of at least one embodiment of the present invention is to provide a plastic part having a layered, decorative, colored-metal finish that meets weathering requirements for UV exposure and the durability requirements for scratching and marring over an extended temperature range.

Another object of at least one embodiment of the present invention is to provide an automotive vehicle interior plastic part having a layered, decorative, colored-metal finish wherein the total energy required to cure the finish is reduced and wherein the finish has a “class A” surface.

In carrying out the above objects and other objects of at least one embodiment of the prevent invention, a plastic part having a layered, decorative, colored-metal finish is provided. The part includes a plastic substrate, a base coat layer overlying the substrates and a continuous decorative metal layer overlying the base coat layer. The part also includes an intermediate color layer having coloring agents and overlying the decorative metal layer. The color layer includes a UV absorber sufficient to stabilize the coloring agents of the color layer by absorbing UV light without adversely affecting the color of the color layer. The part further includes a clear top coat layer overlying and protecting the color layer.

The base coat layer may be a PVD base coat layer and the metal layer may be a PVD layer.

The metal layer may be a VM layer and the colored-metal finish may be a copper finish.

The part may be a plastic trim part.

The base coat layer may be radiation-cured, the top coat layer may be radiation-cured, and the color layer may be thermally-cured. The base coat layer may be in contact with the substrate, the metal layer may be in contact with the base coat layer, the color layer may be in contact with the metal layer, and the top coat layer may be in contact with the color layer.

Further in carrying out the above objects and other objects of at least one embodiment of the present invention, a vehicle plastic part having a layered, decorative, colored-metal finish is provided. The part includes a plastic substrate, a base coat layer overlying the substrate, and a continuous decorative metal layer overlying the base coat layer. The part also includes an intermediate color layer having coloring agents and overlying the decorative metal layer. The color layer includes a UV absorber sufficient to stabilize the coloring agents of the color layer by absorbing UV light without adversely affecting the color of the color layer. The part further includes a clear top coat layer overlying and protecting the color layer.

The base coat layer may be a PVD base coat layer and the metal layer may be a PVD layer.

The base and top coat layers may be radiation-cured and the color layer may be thermally-cured.

Yet still further in carrying out the above objects and other objects of at least one embodiment of the present invention, an automotive vehicle interior plastic part having a layered, decorative, colored-metal finish is provided. The part includes a plastic substrate, a radiation-cured base coat layer overlying the substrate, and a continuous decorative metal layer overlying the base coat layer. The part also includes a thermally-cured intermediate color layer having coloring agents and overlying the decorative metal layer. The color layer includes a UV absorber sufficient to stabilize the coloring agents of the color layer by absorbing UV light without adversely affecting the color of the color layer. The part further includes a radiation-cured clear top coat layer overlying and protecting the color layer.

The base coat layer may be a PVD base coat layer and the metal layer may be a PVD layer.

The part may be a plastic interior trim part having a “class A” surface.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### BRIEF DESCRIPTION OF THE DRAWINGS

FIG. 1 is a view, partially broken away and in cross section, of a plastic part constructed in accordance with at least one embodiment of the present invention; and

FIG. 2 is a block diagram flow chart of many of the process or method steps to make the plastic part of FIG. 1.

### DETAILED DESCRIPTION OF EXAMPLE EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

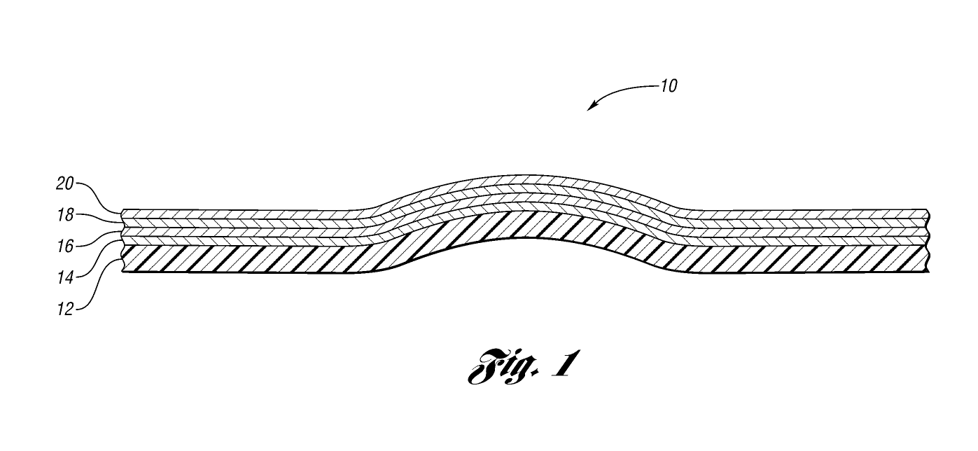

Referring now to FIG. 1, a plastic part such as an automotive interior plastic part having a layered, decorative, colored-metal finish constructed in accordance with at least one embodiment of the present invention is generally as indicated at 10. The part 10 includes a plastic substrate 12 and a plurality of layers that comprise a preferred arrangement for applying a decorative colored-metal finish to the plastic substrate 12. The layer arrangement on the substrate 12 is as follows: a radiation-cured, clear base coat layer 14; a decorative metal layer 16; a thermally-cured, intermediate, pigmented or otherwise colored layer 18; and a radiation-cured, clear top coat layer 20.

As seen in FIG. 1, the base coat layer 14 is applied onto and overlies the substrate 12, followed by the metal layer 16 which is applied onto and overlies the base coat layer 14, followed by the color layer 18 which is applied onto and overlies the metal layer 16, followed by the top coat layer 20 which is applied onto and overlies the color layer 18. It is understood that the layer arrangement shown in FIG. 1 can include additional layers between or on top of its layers 14-20.

The radiation-cured layer 14 of FIG. 1 is applied onto and overlies the substrate 12. The radiation-cured layer 12 provides a smooth, level surface to which the decorative metal layer 16 can be applied and further eliminates or reduces the need for additional surface treatment of the substrate 12. Applying the radiation-cured layer 14 over the substrate 12 can eliminate small surface defects, such as pinholes or fine scratches on the substrate 12. These small surface defects on the substrate 12 would otherwise be highlighted in the decorative metal layer 16 if not abated through surface treatment methods. As such, the radiation-cured layer 14 prevents and makes unnecessary further surface preparation of the substrate 12 to remove such defects. Additionally, the radiation-cured layer substrate 12 provides a smooth, level surface that requires less energy and cure time than that necessary for a heat-cured layer.

The radiation-cured layer 14 provides a desirably smooth surface that exhibits excellent adhesion to the metal layer 16. Specifically, the radiation-cured layer 14 exhibits high surface tension in air once cured, which promotes increased adhesion with the decorative metal layer 16 applied thereto. Strong adhesion between the radiation-cured layer 14 and the decorative metal layer 16 provides significant durability to environmental conditions. Furthermore, the adhesion between these layers is sufficient to withstand subsequent heating in the coating process discussed herein, as well as high temperature applications.

A preferred radiation-cured layer 14 is provided as a radiation-curable material, preferably an acrylated or methacrylated polyester urethane liquid, that is deposited on the substrate 12 and then cured to provide the cured layer 14. Typically the radiation-cured layer 14 is comprised of a polymeric film forming material, a radiation sensitive monomer having polymerizable unsaturated bonds, a photopolymerization initiator, and an inert solvent vehicle. The material for the radiation-cured layer 14 should be chosen to produce or provide surface properties that are advantageous to receive a vapor deposited metal layer. For example, a preferred product, Eureka UV #10218 available from Yoolim Special Chemical Co. Ltd., has a unique receptivity to various metals. Vapor deposited copper exhibits good adhesion to such a UV radiation-cured layer.

Conventional additives can be incorporated or added into the radiation-cured material layer 14 to impart desired properties thereto. Such additives may include, e.g., polymeric or silicone coating surface improvers, flow improvers, dyes, pigments, flattening agents, anti-foaming agents, light stabilizers and antioxidants, in varying amounts dependent upon desired function and performance of the final coating film. In the composition of the radiation-cured layer 14, it is important to consider that many conventional additives are not required and must be reviewed for any detrimental interference with the metal deposition process.

Suitable inert solvents include ethyl acetate, butyl acetate, acetone, methylisobutylketone, methylethylketone, butyl alcohol, isopropanol, toluene, xylene, or a mixture of solvent types.

Application of the radiation-cured layer 14 can be accomplished by several techniques known to the industry, such as conventional air atomized spray, conventional air atomized spray with electrostatic charge, electrostatic rotary atomized application as well as others. It is preferred that electrostatic charge spraying is used for its desirable transfer efficiency and uniform thickness of the applied radiation-cured layer 14.

The radiation-cured layer 14 can be cured by irradiation with ultraviolet rays by conventional methods. Preferably, before the radiation-cured layer 14 is exposed to ultraviolet radiation, the layer 14 is heated to a temperature in the range of about 55 to 65° C. Such moderate or mild pre-heating of the radiation-cured layer 14 is advantageous to promote or cause the thick, viscous layer 14 to flow, thereby presenting a more uniformly flat, even surface. The pre-heating also allows the radiation-cured layer 14 to devolatize, i.e. to evaporate solvents from the layer 14 before it is cured. Heating of the radiation-cured layer 14 can be accomplished by conventional means. It is desirable to heat the radiation-cured layer 14 for a length of about 5 minutes. The radiation-cured layer 14 is then exposed to ultraviolet radiation.

Ultraviolet radiation sources include, but are not limited to, sunlight, mercury lamps, arc lamps, zenon lamps, and gallium lamps.

The metal layer 16 of FIG. 1 is applied onto and overlies the radiation-cured layer 14 to provide a decorative or aesthetic appearance to the substrate 12. Preferably, the decorative metal layer 16 is applied over the radiation-cured layer 14 in atomized form. The decorative metal layer 16 can be applied via one of several vacuum metallizing deposition techniques know to the industry, such as physical vapor deposition, chemical vapor deposition, magnetron sputtering and plasma deposition. Of these processes, physical vapor deposition is the most desirable in the present application. Each of these methods requires a target metal to be atomized, usually in a vacuum chamber, by electric charge, heating or pressurized inert gas. Atoms of the metal are carried to the surface onto which the atoms are to be deposited, and they are deposited thereon until a desired thickness is achieved. The decorative metal layer 16 adheres to the radiation-cured layer 14 as a decorative surface.

Metals suitable for depositing as the decorative metal layer 16 include, but are not limited to, aluminum, nickel, nickel chromium alloy, titanium, chromium, stainless steel, gold, platinum, zirconium, silver, copper, combinations thereof and alloys thereof

The thermally-cured intermediate, pigmented (or other coloring agents) color layer 18 is applied onto and overlies the metal layer 16. The color layer 18 provides a smooth surface that exhibits excellent adhesion to the metal layer 16. A preferred product “Eureka Primer R#382” (urethane type middle) is available from Yoolim Special Chemical Co. Ltd. The color of the pigments in the layer 18 is typically the same or similar to the color of the layer 16 to provide a rich, deep color which is not faded during curing. Rather, the color layer is preferably thermally cured at a temperature in the range of 75-85° C. for approximately 10 minutes.

UV inhibitors or absorbers are added to the color-producing pigment layer 18 sufficient to meet weathering requirements for UV exposure. Also, the thermally cured painted layer 18 with UV inhibitors or absorbers reduce the total energy required to cure the coating system.

The radiation-cured, clear top coat layer 20 of FIG. 1 is applied onto and overlies the color layer 18 to prevent oxidation and environmental damage to the color layer 18. Preferably the composition of the top coat layer 20 is provided by the commercial product Eureka UV #172018 also available from Yoolim. The method of applying and curing the top coat layer 20 is substantially the same as that described above with respect to the layer 14.

The top coat layer 20 has a dry or cured thickness at least effective to protect the surface of the color layer 18, as well as the underlying layers and the substrate 12. Scratching per automotive requirements is limited to top coat penetration, making scratches less apparent to the consumer.

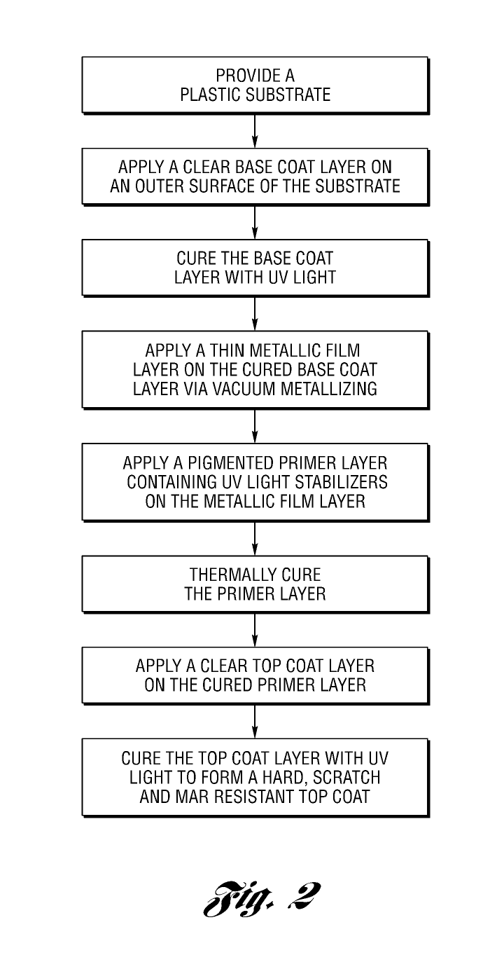

FIG. 2 shows a top level diagram for a process of applying a decorative metal-colored finish to a substrate according to an embodiment of the invention. As seen from the diagram, the four principal stages for such a process are: applying a radiation-cured layer onto and overlying the substrate; applying a decorative metal layer onto and overlying the radiation-cured layer; applying a color layer onto and overlying the decorative metal layer; and applying a top coat layer onto and overlying the colored layer. As will be evident from the figure, each of these stages includes or incorporates a number of steps. Steps illustrated in FIG. 2, which are not discussed hereinabove, are considered to be conventional and well known to persons having ordinary skill in the art, and for that reason are not discussed in further detail herein. It is considered that an important aspect of the present invention is the provision and deposition of the color layer.

The process shown in FIG. 2 is suitable for applying layers to a substrate in a batch or continuous manner, or a combination thereof. For example, in a batch process, the substrate is stationary during each stage of the process. In contrast, the substrate in a continuous process would move along a conveyer line.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A plastic part having a layered, decorative, colored-metal finish, the part comprising:
a plastic substrate;
a base coat layer overlying the substrate;
a continuous decorative metal layer overlying the base coat layer;
an intermediate color layer having coloring agents and overlying the decorative metal layer, the color layer including a UV absorber sufficient to stabilize the coloring agents of the color layer by absorbing UV light without adversely affecting the color of the color layer; and
a clear top coat layer overlying and protecting the color layer.

2. The part as claimed in claim 1, wherein the base coat layer is a PVD base coat layer and the metal layer is a PVD layer.

3. The part as claimed in claim 1, wherein the metal layer is a VM layer.

4. The part as claimed in claim 1, wherein the colored-metal finish is a copper finish.

5. The part as claimed in claim 1, wherein the part is a plastic trim part.

6. The part as claimed in claim 1, wherein the base coat layer is radiation-cured.

7. The part as claimed in claim 1, wherein the top coat layer is radiation-cured.

8. The part as claimed in claim 1, wherein the color layer is thermally-cured.

9. The part as claimed in claim 1, wherein the base and top coat layers are radiation-cured and the color layer is thermally-cured.

10. The part as claimed in claim 1, wherein the base coat layer is in contact with the substrate.

11. The part as claimed in claim 1, wherein the metal layer is in contact with the base coat layer.

12. The part as claimed in claim 1, wherein the color layer is in contact with the metal layer.

13. The part as claimed in claim 1, wherein the top coat layer is in contact with the color layer.

14. The part as claimed in claim 1, wherein the metal layer is in contact with the base coat layer and the color layer.

15. A vehicle plastic part having a layered, decorative, colored-metal finish, the part comprising:
a plastic substrate;
a base coat layer overlying the substrate;
a continuous decorative metal layer overlying the base coat layer;
an intermediate color layer having coloring agents and overlying the decorative metal layer, the color layer including a UV absorber sufficient to stabilize the coloring agents of the color layer by absorbing UV light without adversely affecting the color of the color layer; and
a clear top coat layer overlying and protecting the color layer.

16. The part as claimed in claim 15, wherein the base coat layer is a PVD base coat layer and the metal layer is a PVD layer.

17. The part as claimed in claim 15, wherein the base and top coat layers are radiation-cured and the color layer is thermally-cured.

18. An automotive vehicle interior plastic part having a layered, decorative, colored-metal finish, the part comprising:
a plastic substrate;
a radiation-cured base coat layer overlying the substrate;
a continuous decorative metal layer overlying the base coat layer;
a thermally-cured intermediate color layer having coloring agents and overlying the decorative metal layer, the color layer including a UV absorber sufficient to stabilize the coloring agents of the color layer by absorbing UV light without adversely affecting the color of the color layer; and
a radiation-cured clear top coat layer overlying and protecting the color layer.

19. The part as claimed in claim 18, wherein the base coat layer is a PVD base coat layer and the metal layer is a PVD layer.

20. The part as claimed in claim 18, wherein the part is a plastic interior trim part.
